(19) United States
(12) Patent Application Publication
(10) Pub. No.: US 2003/0036917 A1
(43) Pub. Date: Feb. 20, 2003

(54) Service provision system and method

(75) Inventors: Thomas D. Hite, Rockwall, TX (US); William B. McGrane, Dallas, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(73) Assignee: Metallect Corporation, Dallas, TX

(21) Appl. No.: 10/133,611

(22) Filed: Apr. 25, 2002

Related U.S. Application Data
(60) Provisional application No. 60/286,478, filed on Apr. 25, 2001.

(51) Int. Cl. G06F 17/60

(52) U.S. Cl. 705/1

(57) ABSTRACT

A service provision method is disclosed. The method comprises creating a plurality of service descriptions to a desired level of exposure, the plurality of service descriptions each having a plurality of parameters. The method also comprises mapping at least a subset of the plurality of parameters from at least one of the plurality of service descriptions to create an Application Integration Metaservice (AIM) linking a set of preconditions necessary to satisfy a request for an effect of one of the plurality of service descriptions and the effect. The AIM is operable to be used to determine a metaservice to be executed utilizing the effect of the at least one of the plurality of service descriptions.

### CROSS-REFERENCE TO RELATED APPLICATIONS

This patent application claims the benefit of Provisional Patent Application Serial No. 60/286,478, entitled Service Switching System, filed on Apr. 25, 2001, the disclosure of which is incorporated herein by reference.

### TECHNICAL FIELD OF THE INVENTION

This invention relates generally to the field of computer systems and, more particularly, to a service provision system and method.

### BACKGROUND OF THE INVENTION

Businesses have responded to advances in technology by deploying a variety of networks, computing platforms, and applications to provide their information services. These disparate systems utilize a multitude of standard and non-standard interface protocols, applications and, in some cases, platforms.

However, each of these disparate systems is typically limited to performing functions for which they were originally developed. Thus, enterprises must provide solutions for integrating these disparate systems so that they meet real-time needs of users as businesses grow, merge, or build partnerships with one another. Unfortunately, current integration approaches, including application and Internet or Web services integration, suffer from a number of disadvantages. For example, some solutions require actual application integration to be performed by developers. Often, such development is costly and consumes time, manpower, and other valuable resources. Moreover, the complexity of developing, as well as maintaining, these solutions, may cause delays in new service deployments and increase the risk that such integration will not actually benefit the business. Moreover, these solutions are difficult to modify to accommodate any changes in business strategy.

### SUMMARY OF THE INVENTION

One aspect of the invention is a service provision method. The method comprises creating a plurality of service descriptions to a desired level of exposure, the plurality of service descriptions each having a plurality of parameters. The method also comprises mapping at least a subset of the plurality of parameters from at least one of the plurality of service descriptions to create an Application Integration Metaservice (AIM) linking a set of preconditions necessary to satisfy a request for an effect of one of the plurality of service descriptions and the effect. The AIM is operable to be used to determine a metaservice to be executed utilizing the effect of the at least one of the plurality of service descriptions.

Another aspect of the invention is a service provision system. The system comprises a storage medium and a server interoperably coupled with the storage medium. The server is operable to create a plurality of service descriptions to a desired level of exposure, the plurality of service descriptions each having a plurality of parameters. The server is also operable to store at least a subset of the plurality of service descriptions in the storage medium, and map at least a subset of the plurality of parameters from at least one of the plurality of service descriptions to create an AIM linking the output of one of the plurality of service descriptions and a set of preconditions necessary to satisfy a request for the output. The AIM is operable to be used to determine a metaservice to be executed utilizing the output of the one of the plurality of service descriptions.

Yet another aspect of the invention is an execution engine. The engine comprises a computing platform and logic interoperably coupled with the platform. The logic is operable to cause a metaservice to be executed, and the metaservice comprises at least one of an effect of one of a plurality of service descriptions created to a desired level of exposure and a set of preconditions necessary to satisfy a request for the effect.

Another aspect of the invention is a service description. The service description comprises a data structure and an effect stored within the data structure operable to be optionally mapped to a set of preconditions of another data structure, and another set of preconditions stored within the data structure necessary to satisfy a request for the effect, according to a desired level of exposure.

The invention may provide the advantage of reducing or eliminating hardwired applications required to integrate disparate systems when using conventional methods. Such an advantage may reduce the resources required to implement such a system, and may reduce the complexity of the computer code needed to integrate systems and, as a result, the complexity of the integrated system as a whole. Moreover, such a system may be easily self-adapted to new applications and scenarios as they arise. Such an advantage allows the new system to accommodate unforeseen changes as they arise by dynamically executing runtime transactions necessary to complete a requested service, regardless of the application, network, or platform on which the service is hosted.

### BRIEF DESCRIPTION OF THE DRAWINGS

For a more complete understanding of the present invention and the advantages thereof, reference is now made to the following descriptions taken in connection with the accompanying drawings in which:

FIG. 1 illustrates a block diagram of an embodiment of a service provision system according to the teachings of the present invention;

FIG. 2 illustrates one embodiment of an XSIS document according to the teachings of the present invention;

FIG. 3 illustrates a flowchart of one embodiment of a service provision method according to the teachings of the present invention; and

FIG. 4 illustrates an example of an Application Integration Metaservice according to the teachings of the present invention.

### DETAILED DESCRIPTION OF THE DRAWINGS

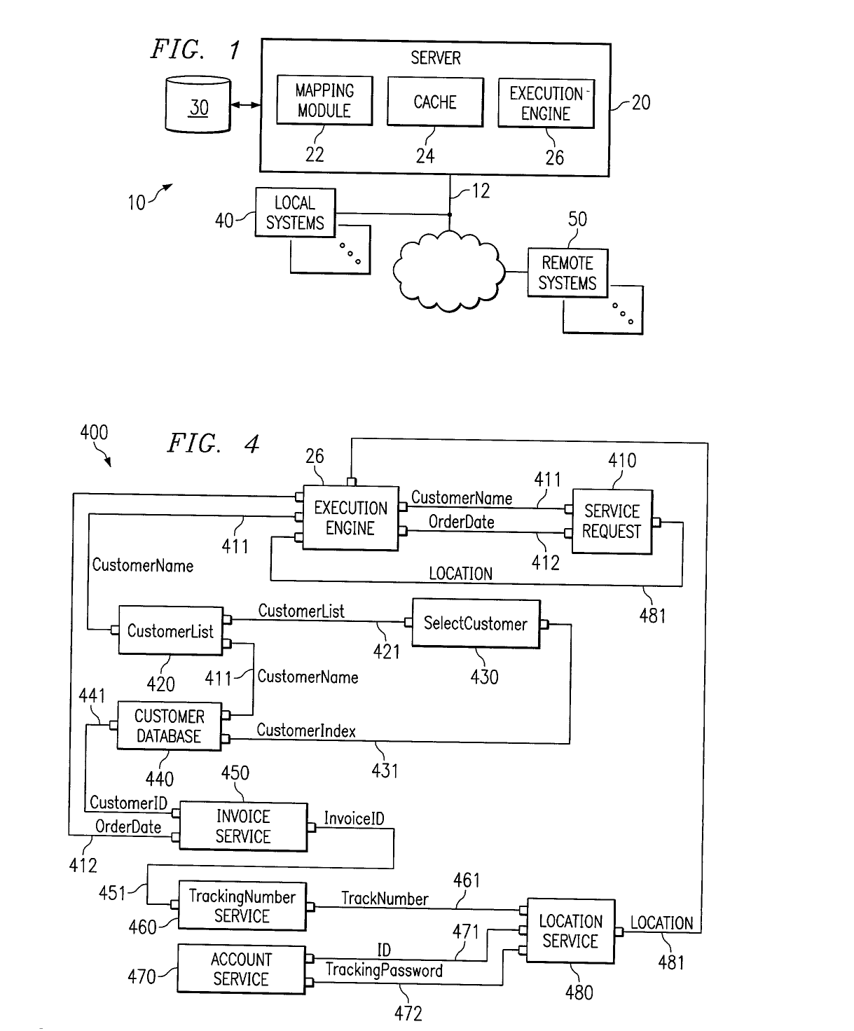

The preferred embodiment of the present invention and its advantages are best understood by referring to FIGS. 1 through 4 of the drawings. FIG. 1 illustrates a block diagram of one embodiment of a service provision system 10. System 10 includes a server 20 operable to communicate with a database 30. The present invention contemplates the use of a variety of methods to perform transactions required to complete service requests to system 10 received over network 15 from one or more local systems 40 and/or remote systems 50. One technical advantage of the present invention is that the invention provides a method that defines syntax and semantics parameters for service descriptions that are required to complete a transaction. Server 20 then is operable to map the syntax and semantics for each service description to determine all possible links in which outputs of the service descriptions can optionally be connected to inputs of the service descriptions. In this description, the collection of these possible links is referred to as Application Integration Metaservices (AIMs). In a particular embodiment, an AIM represents a permutation of all of the possible links between service descriptions, in which one or more particular outputs can be connected to inputs. In other words, the services may be chained together to result in the one or more particular outputs. Server 20 may then cause execution of all of the transactions necessary to fulfill a service request received from one or more of systems 40 and/or 50.

In the embodiment illustrated in FIG. 1, server 20 includes a mapping module 22, a cache 24, and an execution engine 26. Although it is illustrative to discuss server 20 as including these elements, server 20 may utilize a variety of architectures, depending on the implementation. Server 20 may control storage and use of service descriptions that are used to define unique transactions that may be performed upon request to server 20 for and/or by local systems 40 and/or remote systems 50. Cache 24 is a storage medium or other memory such as a random access memory (RAM) that may be suitable for temporarily storing all or a portion of software programs, service descriptions, and/or other data during various processes performed by server 20. Cache 24 may be used, among other things, to support real-time analysis and/or for storing and/or processing of data. Mapping module 22 and execution engine 26 may include special purpose digital circuitry, which may be, for example, application-specific integrated circuitry (ASIC), state machines, fuzzy logic, as well as other conventional circuitry. In other embodiments, mapping module 22 and execution engine 26 may include software or firmware that includes procedures or functions and, in some embodiments, may be user-programmable as desired. Also in other embodiments, mapping module 22, cache 24, and/or execution engine 26 may reside external to server 20 or be standalone components.

Server 20 may receive service requests from local systems 40 and/or remote systems 50 via a network 15. Network 15 may include one or more networks, which may include the public switched telephone network (PSTN), local area networks, wide area networks, a global telecommunications network such as the Internet, and may include wireless networks. Local systems 40 and remote systems 50 are used to represent a variety of platforms, such as wireless devices, storage media such as databases, computers, appliances, peripherals, network elements, including software or other logic processes that may be hosted on such platforms, and others, from which server 20 may receive a service request. System 10 may then advantageously cause execution of those transactions necessary to perform the service request, using those heterogeneous protocols and technologies that may comprise local systems 40 and remote systems 50. Transactions may be atomic services, such as a service represented by a function call in an application on a local system 40 exposed by the Simple Object Access Protocol (SOAP), or an encapsulating service, which “encapsulates” many transactions that are executed across local systems 40 and/or remote systems 50, but is exposed as a single transaction, such as a method call in a Common Object Request Broker Architecture (CORBA) object, or any such combination of transactions as desired by the user of the teachings of this invention.

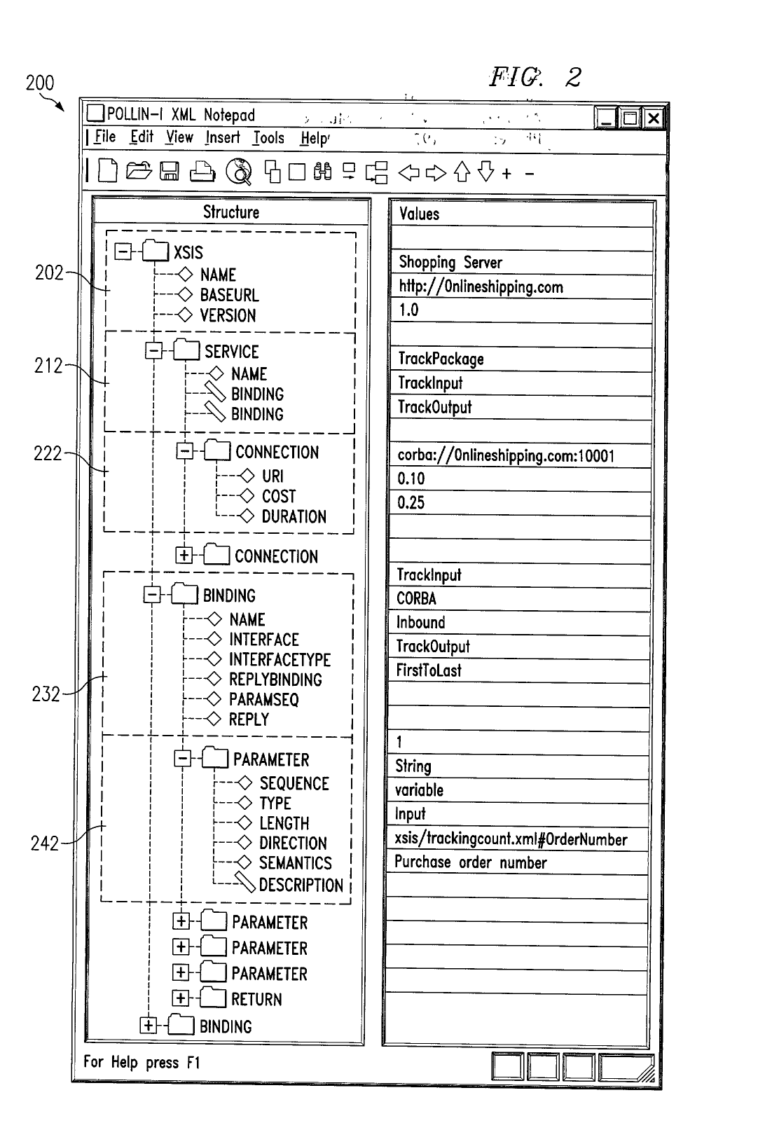

To provide a foundation from which mapping module 22 and execution engine 26 may draw, one embodiment of the invention may perform service discovery to create service descriptions that use Extensible Markup Language (XML) data structures. Service discovery includes providing a disaggregated view of the information and network services found in system 10. Service discovery includes populating database 30 with service descriptions of unique transactions so that server 20 may perform services upon request by users and/or systems 40 and/or 50. Service descriptions may be created to a level of desired exposure, depending on the implementation. For example, a business may desire extensive or complex business transactions to be created as one or more encapsulating services. On the other hand, another business may desire to create service descriptions to a level of exposure that include only atomic services such as single function calls. Yet other businesses may desire exposure to varying levels sufficient for their business. The levels of exposures for service description may vary from the smallest transaction to an encapsulating service that may be globally executed. The invention contemplates encapsulating services as having no upper limit to the number or scope of encapsulated transactions. Each service description includes associated preconditions, otherwise known as inputs, and effects, otherwise known as outputs, all of which may be defined in an ontology. Each transaction includes at least one effect, or output, generated as a result of executing the transaction, and may include a set of preconditions, or inputs, which are required by the transaction to generate the output(s). In some cases, there may be no preconditions necessary to satisfy the request for an effect. Thus, the set of preconditions is empty. One example is a transaction account service 470 discussed in conjunction with FIG. 4. Examples of transactions include, but are not limited to, performing a read operation on an SQL database, initiating an e-business process or an e-commerce exchange, calling a method contained within a CORBA object, calling a remote function using SOAP, or other any other remote method invocation. For example, in order to obtain a record set from an SQL database as an effect, a transaction might require preconditions, or inputs, such as the location of the database and the SQL statement to obtain the result. Although the invention contemplates a variety of methods for describing transactions, one embodiment for describing a transaction includes storing instructions for invoking the transaction in Interface Definition Language (IDL) form, or as executable codes such as a JAVA applet or script. For ease of illustration, service descriptions may be referred to in this description as XML Semantic Integration Standard (XSIS) documents. One example for an XSIS document is discussed in conjunction with FIG. 2.

After service discovery is performed to create the service descriptions, mapping is performed to create an AIM, or set of AIMs, based upon the effect(s) desired. For example, a set of AIMs may include all of the permutations of linked transactions that may be back-solved for the effect returning a record set from an SQL database. In one embodiment, mapping module 22 may be used to perform such back-solving. The AIMs may then be traversed through one or more of the described transactions to arrive at the desired effect. It is instructive to note that there can be multiple AIMs that generate the same outputs or effects given a particular set of inputs. What differentiates such a set of AIMs is the path of transactions required to perform the service request for the particular effect. Each AIM may include heterogeneous transactions employing technologies such as SOAP, CORBA, DCOM, JAVABEANS, .NET, and future technologies now known or developed in the future such as, but not limited to, RosettaNet, cXML, and BIZTALK. For example, a service request may require execution of one or more varied transactions such as, but not limited to, database calls, Internet or Web services, and/or functional calls from one or more disparate systems.

It may be illustrative to describe database 30 as including an ontology that defines the types of resources used by server 20. Database 30 may represent one or more actual databases, and may be implemented using one or more technologies such as, but not limited to, Extensible Markup Language (XML), Resource Description Framework (RDF), and Lightweight Directory Access Protocol (LDAP). A resource may be used according to the parameters such as a precondition, or input, or an effect, or output, of a given application, functional, or transaction service. In a particular embodiment, an ontology entry may contain a logical definition of a resource, its attributes, the range of values for each attribute, constraints between attribute values and the relationships between the resources attributes and those of other resources. An ontology may be used to resolve varying semantics between disparate systems. For example, one service may label zip code information as “ZIP”, while another service may utilize a label “ZIP CODE”. By utilizing a semantic mapping establishing that these terms are equivalent, so that programmatic interaction with, and mapping linkages between, a variety of disparate services may be executed effectively and easily.

Also in a particular embodiment, database 30 may include a transactions section that provides a definition of service specifics including, but not limited to, location such as a Uniform Resource Locator (URL), communication protocol such as, but not limited to, TCP/IP, transaction interface such as, but not limited to, CORBA, required input or preconditions, and generated outputs or effects.

Again, in a particular embodiment, database 30 may include a resources section that defines specific instances of resource types defined by an ontology. For example, a resource has an associated type, various attributes and other information such as, but not limited to, a quantity available, or a status of an external- link to availability. Such a section may be advantageous for, among other things, providing a mechanism for uniquely mapping preconditions and effects as similar or identical in meaning, and thus making these preconditions and/or effects available for linking together with other preconditions or effects with the same ontology entry.

Mapping module 22 is operable to create AIMs by solving for all, or at least a subset of, the transactions possible that create a particular effect. If an AIM is solved results in only a subset of the transactions necessary to create a particular effect, then it may be called a Dead End AIM. A Dead End AIM may be useful to highlight those AIMs that could be completed were the missing inputs to the Dead End AIM to be made available, such as by describing a transaction that produces, as its output or effect, the missing input(s) of the Dead End AIM. Each AIM includes one entry point, requiring a set of preconditions required to invoke, or execute, the AIM, thereby producing the particular effect(s). Thus, because traversal of the AIM results in the desired effect(s), any AIM may encapsulate one or more other AIMs, each of which requires different inputs than the encapsulating AIM, but results in the same effects or outputs. In one embodiment of mapping module 22, a solver is an algorithm such as one of the known Rete forward-chaining solvers, or Rete algorithms, which are well-known methods for pattern matching that use rules to solve for preconditions that result in one or more desired effect. In a particular embodiment, the Rete algorithm may be called iteratively for all effects described by the service descriptions.

Although the invention contemplates a number of protocols, languages, and discovery services now known or that are developed in the future, TABLE I describes several protocols may be used according to the teachings of the invention, for illustrative, and not limiting, purposes.

TABLE I
EXAMPLES OF SERVICE COMMAND
AND CONTROL PROTOCOLS

| Protocol | Description |
|---|---|
| UDDI | Universal Description, Discovery and Integration |
| TpaML | Trading Partner Agreement Markup Language |
| WSDL | Web Services Description Language |
| XAML | Transaction Authority Markup Language |
| SSDP | Simple Services Discovery Protocol |
| DNS | Domain Name Service |
| LDAP | Lightweight Directory Access Protocol |
| CORBA Trader | Common Object Request Broker |
| Service | Architecture Trader Service |
| Salutation | Salutation |
| SLP | Service Location Protocol |
| Jini | Jini |
| SSDS | Secure Service Discovery Service |
| SDP | SOAP Discovery Protocol |
| UDDI | Universal Description Discovery and Integration |
| SCL | SOAP Contract Language |
| WSDL | Web Services Description Language |
| Salutation | Salutation Resource Manager |
| RDF | Resource Description Framework |
| XP | XML Protocol |
| SOAP | Simple Object Access Protocol |
| XML-RPC | XML Remote Procedure Call |
| WebBroker | Distributed Object Communication on the Web |
| WDDX | Web Distributed Data eXchange |
| XMI | Metadata Interchange |
| BizTalk | BizTalk Protocol |
| EbXML | Electronic Business XML |
| GENA | Generic Eventing and Notification Architecture |
| UpnP | Universal Plug-n-Play |

An example may be illustrative. A customer may purchase an item from an online retail site such as www.onlinebooks.com, which may have a relationship with a shipping company who is online at www.onlineshipping.com. These two companies work together to route customers' orders to their delivery addresses. Consider a scenario in which the customer requests whether a sales order has been delivered by the shipping company.

In an information services environment, the present invention may be used to integrate what would otherwise be human-to-human processes necessary to harness the power of these legacy systems. Before partnering, each of the online sites might utilize legacy systems where, for example, www.onlineshipping.com would not need to know the customer's name, and www.onlinebooks.com would not need to know a tracking number for each customer. For example, www.onlinebooks.com's system may include a customer ID and a customer name, while www.onlineshipping.com may utilize tracking numbers and a tracking status such as whether the customer has received the package. In order to provide their customers efficient service, system 20 may be utilized in such a partnership to map transactions for obtaining shipping tracking numbers, customer ID, and orders not received by the customer.

In other words, when a sales person or customer submits requests for orders in transit associated with a given customer name, server 20 may then map the request to transactions within an AIM to fulfill the request. In this example, four service descriptions may be used to describe the parameterizations for the output of tracking information resulting from the input of a tracking number; the output of a tracking number resulting from the input of an order number; the output of an order number resulting from the input of a customer ID; and for the output of a customer ID resulting from the input of a customer name. Although the AIM includes the transactions required for execution upon receipt of the customer name to return the tracking information, mapping module 22 may include more than these four service descriptions for its tracking information AIM. One example for an AIM resulting in an effect of tracking information is discussed in conjunction with FIG. 4.

System 10 may then cause these transactions to be executed, and returns those orders not received to the requester. In one embodiment, execution engine 26 invokes execution of these transactions and, when the effect is obtained, returns the effect to the requester. As a continuation to the same example, system 20 causes a customer ID to be fetched from a first application or database using a customer name as input. If the customer name is not unique, the unique customer ID may be selected by the requestor after system 10 causes a list of customer names and IDs to be presented to the requestor. Then, using the customer ID as input to a second application or database, system 20 may cause one or more active tracking numbers associated with the customer ID to be fetched. Using these tracking numbers as input to a third application or database, system 20 may cause those orders not received by customers to be fetched.

Some or all of the transactions may be performed by server 20, local system 40, and/or remote system 50 using applicable technologies. In a particular embodiment, performance of transactions may be accomplished by using agent technologies, which are well-known. Examples of such agents that may be used include, but are not limited to, interface agents to handle requests and/or interfaces with humans or processes such as a SQL server process, task agents to invoke services, facilitator agents to deliver addresses of known agents able to complete a transaction, create needed agents, and/or search for existing agents to perform a transaction, and diagnostic agents to handle diagnostic and status information.

FIG. 2 illustrates one embodiment of an XSIS document according to the teachings of the present invention. As illustrated in FIG. 2, XSIS document 200 includes a description section 202, a service section 212, a connection section 222, a binding section 232, and a parameter section 242. As will be discussed in conjunction with FIG. 4, FIG. 4 illustrates the concept of multiple transactions that must occur in order to carry out any particular AIM. There is no guarantee or implication that disparate transactions in any particular AIM can be invoked with identical call syntaxes or protocols, or even that the transactions exist on a single machine. In order to allow the present invention to make use of the service descriptions, each service description provides for the inclusion of sufficient explanation of the interface and protocol mechanisms required for calling the transactions—in other words, causing the transactions to be executed. For example, description section 202 provides for a human readable description of a particular service. Service section 212 provides for a mechanism to specify metadata about the transaction, such as the name of the transaction and names of atomic functional capabilities of the service. Binding section 232 provides for a description of how software can bind to and invoke the service, such as the call procotol (e.g., CORBA, DCOM, or other suitable protocol) and information pertaining to the inputs and outputs of the service. Inputs and outputs are described in parameter sections 242.

In a particular embodiment and to further illustrate the operation of system 10 utilizing the examples discussed above in conjunction with FIGS. 1 and 4, XSIS description section 202 includes a name “Shipping Server”; a base Uniform Resource Locator (URL) http://onlineshipping.com, and a version “1.0”.

In service description 212, XSIS document 200 includes a name “TrackPackage” and, in the embodiment illustrated in FIG. 2, two binding values “TrackInput” and “TrackOutput”. XSIS document 200 also includes a connection section 222 with a URL that has a value “corba://onlineshipping.com:10001”. Connection section 222 also includes a cost of “0.10” and a duration of “0.25” associated with service 212. These values may be structured as desired. For example, and in a particular embodiment, connection 222 may also include a resource absorption rate, wait period, or other parameters, and these parameters may utilize any units such as seconds, microseconds, days, or other applicable unit.

Binding 232 includes, in this example, a name “TrackInput”, an interface “CORBA”, and an interfacetype of “Inbound”. Binding section 232 also includes a replybinding value of “TrackOutput”, and a parameter sequence (paramseq) value of “FirstToLast”. Parameter section 242 includes a sequence value of “1”, a type “string”, a length “variable”, and a direction “input”. Parameter section 242 also includes a semantics value of “xsis/trackingcount.xml#OrderNumber” and a description of value “PurchaseOrderNumber”.

As illustrated and for example, XSIS document 200 includes a single service description 212, multiple connection descriptions 222, multiple binding descriptions 232, and multiple parameter descriptions 242. Although not illustrated, XSIS documents 200 may include any desired parameters necessary to implement a particular service description, depending on the application. The present invention also contemplates numerous methods for implementing service descriptions other than XSIS documents including, but not limited to, as well as those methods that may be developed in the future.

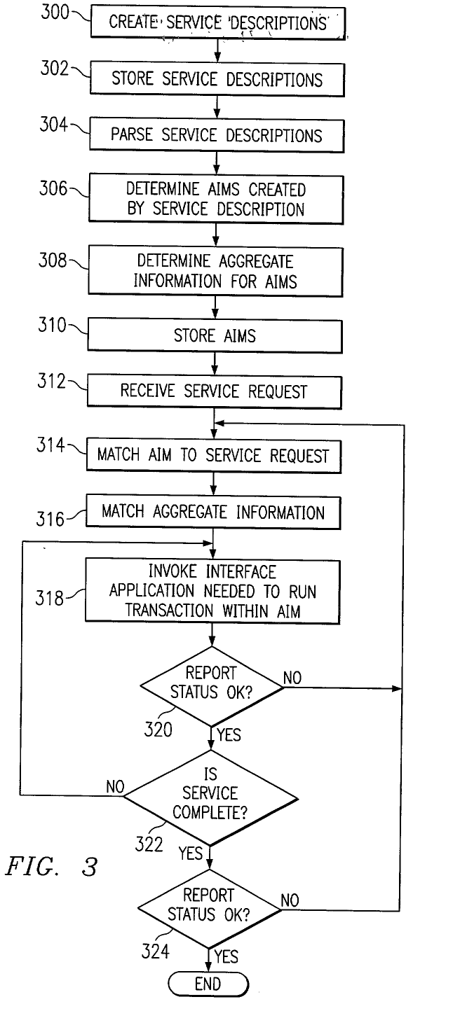

FIG. 3 illustrates a flowchart of one embodiment of a service provision method according to teachings of the present invention. Various embodiments of the method may have fewer or more steps and, in a particular embodiment, some steps may be optional. The method generally includes creating service descriptions and mapping those service descriptions to produce AIMS so that, when a service request is received, the service request may be performed by selecting and executing the applicable AIM.

The method begins at step 300, where service descriptions are created. These may be manually and/or automatically created, and the number of service descriptions varies according to the application and depending on the implementation. Moreover, as previously discussed, some businesses may wish to expose service descriptions to atomic levels whereas others may wish to encapsulate their service descriptions at higher levels of exposure. In step 302, these service descriptions are stored. As one example, these service descriptions may be stored in database 30, where they may be retrieved as desired. The method proceeds to step 304.

In a particular embodiment, steps 304-310 may be performed by mapping module 22. In step 304, mapping module 22 parses the created service descriptions. This step may include storing some or all of the service descriptions in cache 24 and/or simultaneously parsing some or all of the service descriptions. Parsing a service description allows mapping module 22 to obtain all preconditions, effects, transaction call methods, aggregate information such as execution costs (such as, but not limited to, time, monetary costs and other resource expenditures), if any, and any other transaction information desirable, according to the implementation. In step 306, mapping module 22 determines one, all, or a subset, of the AIMs that can be created, given the described service descriptions that result in a given effect(s). In a particular embodiment, mapping module 22 may utilize the parsed information to determine all possible AIMs that may be created by supplying all permutations of preconditions and goals to a solver such as a logic engine utilizing a Rete algorithm (a Rete engine). Such an engine may be hardware, software, firmware, or a combination thereof. In step 308, aggregate information may be determined for the AIMs determined in step 306. Aggregate information may be used by server 20 when executing service requests received in step 312 to determine which AIM(s) may be used for any given request. For example, requests may require that the service to be performed is the most cost-effective, the fastest, or utilize the fewest resources. In such scenarios, server 20 may choose different AIMs, depending on their aggregate information. In step 310, the AIMs may be stored in database 30 using a variety of methods, including databases such as SQL, relational, flat file, or any other data structure. In a particular embodiment, aggregate information may be stored with an AIM. The method proceeds to step 312.

In a particular embodiment, steps 312-318 may be performed utilizing an execution engine 26. Steps 312-318 describe server 20 processing the service request and then invoking other processes to perform the transactions necessary to complete the service request. In step 312, server 20 receives the service request in any suitable form. For example, server 20 may execute interface software that accepts service requests from client applications. Service requests include transaction inputs, a description of a desired output, and a parameter such as a cost function that may be used to select an applicable AIM. In step 314, server 20 matches an AIM to the service request and, in step 316, matches aggregate information to the service request. In step 318, server 20 may invoke interface software necessary to run a transaction within the selected AIM. For example, server 20 may dynamically create and start a CORBA software interface in order to execute a transaction on a CORBA service. In step 320, status may be reported. As an example, such status may be used to determine whether a failure occurred during execution of the AIM. If so, the process may be started over with the selection of a new AIM if one is available. As illustrated in FIG. 3, if such status denotes a failure, the method returns to 314 where another AIM is matched to the service request. If the status is successful in step 320, the method then continues to step 322 where the method queries whether the service request has been completed. If the service request has not been completed, the method returns to step 318 to invoke the next transaction to be run within the AIM. On the other hand, if the service request has been completed in step 322, the method reports a final status in step 324. If the reported status is not successful in step 324, the method returns to step 314 to match another AIM to the service request. If the reported status is successful in step 324, the method ends.

FIG. 4 illustrates an example of an AIM according to the teachings of the present invention. FIG. 4 illustrates an AIM 400 in which multiple transactions are linked together by mapping outputs to inputs according to teachings of the present invention and whose execution is coordinated by execution engine 26. The transactions illustrated in FIG. 4 include a service request 410, customer list 420, select customer 430, customer database 440, invoice service 450, tracking number service 460, account service 470, and location service 480. Service request 410 represents the entry point to AIM 400, and provides as outputs a customername 411 and orderdate 412 for which location 481 is the effect of the request. Outputs customemame 411 and orderdate 412 of service request 410 are directed to execution engine 26, which recognizes the request and begins solving for the requested location 481, which it returns as an input to service request 410.

Execution engine 26 causes execution of customer list 420, which is a transaction that provides a list of customer name data records, identified here as customer list 421, that are associated with input customer name 441. If, for example, more than one customer name record matches, execution of AIM 400 causes execution of the transaction select customer 430 which provides, as output, a unique customer index 431 from its input customer list 421. If, on the other hand, customer list 420 provides as its output only a single customer name 411, select customer 430 is not executed as part of AIM 400.

In either case, with a single customer name 411, execution of AIM 400 continues to transaction customer database 440, whose input is a single customer name 411 and whose output is a unique identifier customer ID 441. Execution of AIM 400 proceeds to transaction invoice service 450, which accepts as its inputs outputs customer ID 441 from customer database 440 and order date 412 from execution engine 26, and generates invoice ID 451 as its output. Invoice ID 451 from invoice service 450 is then used as input to tracking number service 460, to generate output track number 461. Execution of AIM 400 then proceeds to transaction location service 480. Location service 480 accepts inputs tracking number 461, ID 471 and tracking password 472. ID 471 and tracking password 472 are generated as outputs by transaction account service 470, which requires no inputs. Location service 480 then generates as its output location 481, which is returned to execution engine 26. Execution engine 26 accepts location 481 as its input, and then provides it to service request 480 to complete the service request that utilizes this example AIM.

The present invention contemplates performing a wide variety of service requests including, but not limited to, large-scale AIMs that include multi-part, global, e-commerce exchanges, and scheduling, facilitating, and playing a variety of media to multiple viewing, performing, and/or listening sites. Integration in the telecommunications area may be envisioned by dynamically creating, provisioning, and deploying value-added application services to residential and enterprise broadband subscribers. As one example, the present invention may reduce the inherent limitations of intelligent network systems that were originally installed to overcome the high cost of mainframe-like proprietary services for telecommunication companies. Unfortunately, those installed systems failed to integrate services with back-office systems for billing, provisioning, network management and customer care. Competitive Local Exchange Carriers (CLECs) and new national network providers who offer a host of telephone, data and Internet services must roll out new services quickly and integrate complex workflow processes within multi-vendor environments, which requires dynamic creation, provisioning and performing scalable, reliable, and real-time complex interactions between separate systems for network events, network software, and back-office applications.

System 20 may also be utilized in an Application Service Provider (ASP) and other service provider environments so that an ASP may deploy a number of application services while balancing network utilization. System 20 may also offer consumers a flexible approach to requesting services that they would like to be performed, such as determining when they will receive a service or sales order, rather than manually executing steps required to achieve that goal. Other contemplated services include facilitating stock transaction management, online financial transactions, integration of cross-partner business data, or any service requiring integration of disparate application and information systems.

While the invention has been particularly shown and described by the foregoing detailed description, it will be understood by those skilled in the art that various other changes in form and detail may be made without departing from the spirit and scope of the invention.

What is claimed is:

1. A service provision method, comprising:
creating a plurality of service descriptions to a desired level of exposure, the plurality of service descriptions each having a plurality of parameters;
mapping at least a subset of the plurality of parameters from at least one of the plurality of service descriptions to create an Application Integration Metaservice (AIM) linking a set of preconditions necessary to satisfy a request for an effect of one of the plurality of service descriptions and the effect; and
wherein the AIM is operable to be used to determine a metaservice to be executed utilizing the effect of the at least one of the plurality of service descriptions.

2. The method of claim 1, further comprising causing the metaservice to be executed.

3. The method of claim 1, further comprising creating the at least one of the plurality of service descriptions by populating a data structure consistent with standards known as Extensible Markup Language (XML).

4. The method of claim 1, further comprising performing the mapping by utilizing one of the group consisting of a solver and a Rete algorithm.

5. The method of claim 1, wherein the metaservice includes at least one of the group consisting of a Web services call, a function call, a database call, a network transaction, a retail transaction, an education transaction, a financial transaction, a corporate transaction, an ASP transaction, a travel transaction, and a medical transaction.

6. The method of claim 1, wherein the set of preconditions is one of the group consisting of no precondition, and a valid authentication code.

7. The method of claim 1, further comprising selecting the metaservice to be executed by using aggregate information within the AIM.

8. A service provision system, comprising:
a storage medium; and
a server interoperably coupled with the storage medium and operable to:
create a plurality of service descriptions to a desired level of exposure, the plurality of service descriptions each having a plurality of parameters;
store at least a subset of the plurality of service descriptions in the storage medium;
map at least a subset of the plurality of parameters from at least one of the plurality of service descriptions to create an AIM linking the output of one of the plurality of service descriptions and a set of preconditions necessary to satisfy a request for the output; and
wherein the AIM is operable to be used to determine a metaservice to be executed utilizing the output of the one of the plurality of service descriptions.

9. The system of claim 8, wherein the storage medium is a cache.

10. The system of claim 8, wherein the storage medium is a database.

11. The system of claim 8, wherein the storage medium comprises an ontology.

12. The system of claim 8, wherein the server comprises an execution engine operable to cause the metaservice to be executed upon request.

13. The system of claim 8, wherein the server is operable to map utilizing one of the group consisting of a solver and a Rete algorithm.

14. The system of claim 8, wherein the server is further operable to select an AIM to be executed by using aggregate information within the AIM.

15. An execution engine, comprising:
a computing platform;
logic interoperably coupled with the platform and operable to cause a metaservice to be executed; and
wherein the metaservice comprises at least one of an effect of one of a plurality of service descriptions created to a desired level of exposure and a set of preconditions necessary to satisfy a request for the effect.

16. The execution engine of claim 15, wherein one of the group consisting of a solver and a Rete algorithm is utilized to map possible links between the plurality of service descriptions create at least one AIM.

17. The execution engine of claim 15, wherein the logic is further operable to call at least one software agent process to execute at least a portion of the metaservice.

18. The execution engine of claim 15, wherein the logic is further operable to select the metaservice to be executed by using aggregate information within an AIM.

19. The execution engine of claim 15, wherein the logic is further operable to receive status information and select another metaservice within an AIM to be executed in response to the status information.

20. The execution engine of claim 15, wherein the logic comprises executable software instructions.

21. The execution engine of claim 15, wherein the plurality of service descriptions are created by populating a data structure consistent with standards known as XML.

22. A service description, comprising:
a data structure;
an effect stored within the data structure operable to be optionally mapped to a set of preconditions of another data structure; and
another set of preconditions stored within the data structure necessary to satisfy a request for the effect, according to a desired level of exposure.

23. The service description of claim 22, wherein the data structure is compatible with standards known as XML.

24. The service description of claim 22, further comprising aggregate information operable to be used to select metaservices to be executed.

25. The service description of claim 24, wherein the aggregate information comprises information from the group consisting of cost information, resource information, transaction duration time, and metadata allowing differentiation of metaservices.

26. The service description of claim 22, further comprising at least one of the group consisting of binding information, parameter information, connection information, service information, and a base address.

27. The service description of claim 22, wherein the effect is one of the group consisting of a Web call, a function call, a database call, a network transaction, a retail transaction, an education transaction, a financial transaction, a corporate transaction, an ASP transaction, a travel transaction, and a medical transaction.
